(19) United States
(12) Patent Application Publication
(10) Pub. No.: US 2004/0056128 A1
(43) Pub. Date: Mar. 25, 2004

(54) Impact grinding apparatus for cereal

(75) Inventors: Shigeki Uebayashi, Tokyo (JP); Makoto Miyaji, Tokyo (JP)

Correspondence Address: STAAS & HALSEY LLP, SUITE 700, 1201 NEW YORK AVENUE, N.W., WASHINGTON, DC, 20005, US

(73) Assignee: SATAKE CORPORATION, Tokyo (JP)

(21) Appl. No.: 10/640,641

(22) Filed: Aug. 14, 2003

(30) Foreign Application Priority Data
Feb. 19, 2002 (JP) 42306/2002

(51) Int. Cl. B02C 19/12

(52) U.S. Cl. 241/74

(57) ABSTRACT

An impact grinding apparatus for grains capable of obtaining ground product having a desired granularity without sifting the product after grinding or changing a screen cylinder as a whole. The impact grinding apparatus comprises an inlet for introducing material to be ground, a rotary disk arranged rotatably under the inlet and having a plurality of vanes arranged at a periphery thereof and directed in an approximately radial direction of the rotary disk, a screen cylinder stationary arranged outside the vanes of the rotary disk, an annular discharging path arranged outside the screen cylinder for discharging ground product. Each of the screen faces of the screen cylinder comprises a plurality of superposed screen plates arranged slidable with each other. The screen cylinder is constituted by a plurality of screen units stacked in the vertical direction.

### BACKGROUND OF THE INVENTION

1. Field of the Invention

The present invention relates to an impact grinding apparatus for grinding granular material particularly such as grains by impact.

2. Description of Related Art

There is known an impact grinding apparatus for grinding grains by impact from U.S. Pat. No. 5,474,238, for example. In this impact grinding apparatus, a centrifugal wheel is fixed to an output shaft of a motor, and a supply pipe for supplying material to be ground is arranged above the centrifugal wheel. The centrifugal wheel comprises an upper stage and a lower state divided by a partition ring, and centrifugal passages are formed for guiding the material supplied from the supply pipe onto the respective stages of the centrifugal wheel. An annular impact ring is arranged outside a circumference of the centrifugal wheel, and a product discharging path is formed around the impact ring. In this impact grinding apparatus, the grains supplied on the respective stages of the centrifugal wheel through the centrifugal passages is threw towards the impact ring by centrifugal force produced by the rotation of the centrifugal wheel, to impact against the impact ring to be ground and the ground product is discharged from the product discharging path.

The ground particles produced from grains is used as material of foods and is often required to have predetermined granularity. Thus, it is necessary to sift the ground product obtained by the above impact grinding apparatus by a sifting device. There is known a sample grinding device incorporated into a measuring apparatus for measuring and analyzing components contained in grains such as rice from Japanese Patent No. 2521475. This sample grinding device comprises a grinding disk connected to an output shaft of a motor, a supply hopper for supplying samples and a plurality of vanes arranged on a periphery of the grinding disk. A porous ring having predetermined mesh size which functions as a screen cylinder is arranged outside the periphery of the grinding disk with a small clearance therebetween, and a particle gathering path is provided outside the porous ring. In this sample grinding device, the grains supplied from the supply hopper onto the grinding disk are threw towards the porous ring by centrifugal force produced by the rotation of the grinding disk and thrust from the vanes, to be ground by impact against the porous ring. As the impact is repeated, the grains are ground to have sizes to pass through the meshes of the porous ring and the ground particles are discharged through the particle gathering path.

In this sample grinding device, it is necessary to change the porous ring as a whole for altering mesh size of the porous ring so as to obtain ground particles having desired granularity.

### SUMMARY OF THE INVENTION

The present invention provides an impact grinding apparatus for grinding grains capable of obtaining ground product having a desired granularity without need of sifting the product after grinding or changing a screen cylinder as a whole.

An impact grinding apparatus of the present invention comprises: an inlet for introducing material to be ground; a rotary disk arranged rotatably under the inlet, and having a plurality of vanes arranged at a periphery thereof and directed in an approximately radial direction; a screen cylinder stationarily arranged outside the plurality of vanes of the rotary disk and having screen faces constituted by a plurality of screen plates detachably mounted thereon; and an annular path arranged outside the screen cylinder for discharging ground product passed through the screen cylinder. Since the screen plates constituting the screen faces are detachable, the screen plates can be easily changed to ones having different mesh sizes and it is not necessary to replace the screen cylinder for changing the mesh size or to sift the ground product after the grinding.

Each of the screen faces of the screen cylinder may comprise a plurality of superposed screen plates arranged slidable relative to each other. With this arrangement, the mesh size of the screen faces can be easily adjusted to be a desired size, and also strength and durability of the screen faces are enhanced by the superposed screen plates.

The screen cylinder may be constituted by a plurality of screen units stacked in the vertical direction, to thus enable a desired combination of screen units having different shapes and mesh sizes.

The screen units may include a round screen unit and a polygonal screen unit. The polygonal screen units allows the supplied material to be fed to comer portions formed between the vanes and the screen plates to increase capability of processing amount of material.

Each of the screen plates may have a plurality of slits extending in the vertical direction. With this arrangement, the slits extend in the direction perpendicular to a rotating direction of the rotary disk, to effectively grind the material and to prevent passing of ground particle having diameter larger than widths of the slits.

At least one of the screen plates is embossed on a side facing the rotary disk such that the material thrown from the rotary disk is impacted on bosses on the screen plates to enhance the efficiency of grinding.

### BRIEF DESCRIPTION OF THE DRAWINGS

FIG. 1 is a plan view of an impact grinding apparatus according to an embodiment of the present invention;

FIG. 2 is a cross sectional view along a line II-II in FIG. 1;

FIG. 3 is an exploded view of a rotary disk with vanes, a polygonal screen unit and a round screen unit;

FIG. 4 is a cross sectional view along a line IV-IV in FIG. 2; and

FIG. 5 is a cross sectional view along a line V-V in FIG. 2.

### DETAILED DESCRIPTION OF PREFERRED EMBODIMENTS

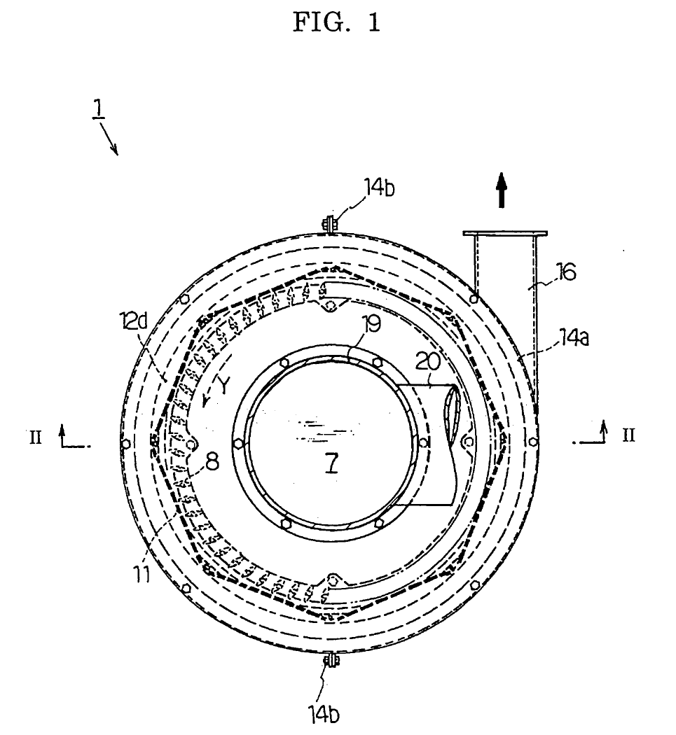

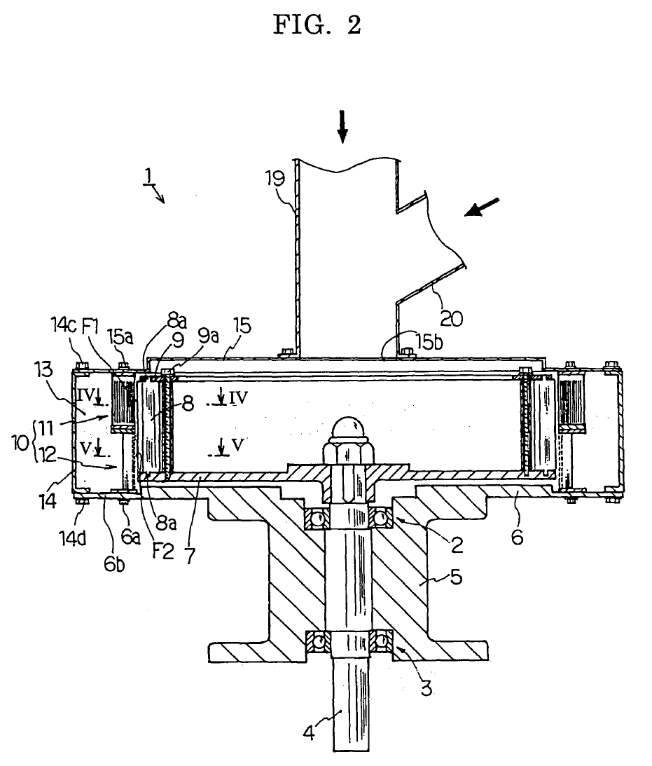

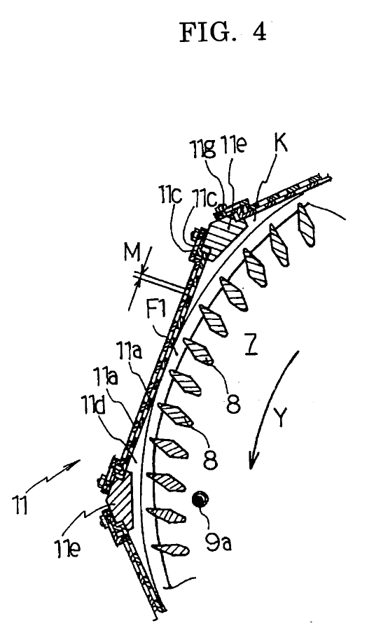

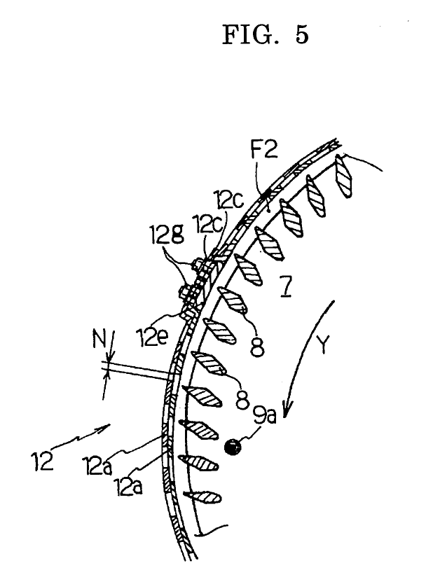

Referring to FIGS. 1 and 2, an impact grinding apparatus 1 comprises a spindle 4 rotatably supported vertically in a cylindrical pedestal 5 by a pair of bearings 2 and 3. A lower end of the spindle 4 is operatively connected to an output shaft of a driving motor (not shown). A round base 6 is formed at an upper end of the cylindrical pedestal 5 integrally therewith. A rotary plate 7 is arranged above the round base 6 with an appropriate clearance therebetween to be out of contact with the round base 6. The rotary plate 7 is fixed to an upper end of the spindle 4 to rotate therewith. A plurality of vanes 8 are arranged with appropriate gaps therebetween to extend approximately radially on an upper side of the rotary plate 7 along a circumference thereof. Each of the vanes 8 has a upright rectangular shape in side view as shown in FIG. 2 and an approximately rhomboidal shape in cross-section as clearly shown in FIGS. 4 and 5. Upper and lower protrusions 8a are formed at upper and lower ends respectively of each vane 8, and each vane 8 is fixed to the rotary plate 5 with the lower protrusion 8a fitted into a concave formed in the rotary plate 7, and fixed to a ring plate 9 with the upper protrusion 8a fitted into a concave formed in the ring plate 9 so that the ring plate 9 covers the upper ends of the vanes 8. Each of the vanes 8 is arranged with the outer end thereof slightly inclined in a direction opposite to a rotating direction Y of the rotary disk 7 with respect to a radial direction of the rotary disk 7, as shown in FIGS. 4 and 5. The ring plate 9 and the rotary disk 7 are connected with each other by bolts 9a as shown in FIG. 2.

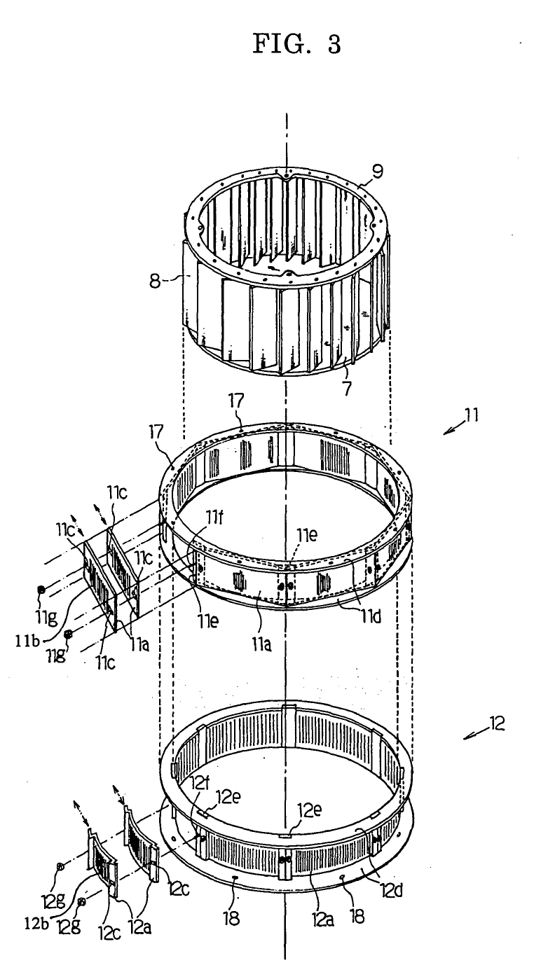

A screen cylinder 10 is arranged around the vanes of the rotary disk 7 with an appropriate clearance therebetween. The screen cylinder 10 comprises a polygonal screen unit 11 at an upper half portion and a round screen unit 12 at a lower half portion. An exploded view of the rotary disk 7 with the vanes 8 and the ring plate 9, and the screen cylinder having the polygonal screen unit 11 and the round screen unit 12 is shown in FIG. 3. In FIG. 3, the vanes 8 arranged on the rotary disk 7 are depicted with the number thereof reduced and the shape thereof abbreviated. The polygonal screen unit 11 has an octagonal shape in this embodiment. A first grinding chamber F1 is formed between the polygonal screen unit 11 and the vanes 8 as shown in FIG. 4, and a grinding chamber F2 is formed between the round screen unit 12 and the vanes 8 as shown in FIG. 5. The first grinding chamber F1 communicates with the second grinding chamber F2 vertically.

In this embodiment, the polygonal screen unit 11 has eight screen faces to form the octagonal shape. Each screen face comprises two screen plates 11a. Each of the screen plates 11a has a plurality of longitudinal through holes (slits) 11b extending in the vertical direction and an oval through hole 11c elongated in the circumferential direction at both side ends thereof. The two screen plates 11a are superposed each other and attached to brackets 11e which are fixed to upper and lower ring plates 11d by welding, etc. Bolts 11f are provided at attachment faces of the brackets 11e for insertion into the oval through holes 11c of the screen plates 11a, and each pair of the two screen plates 11a are detachably mounted on the attachment faces of the adjacent brackets 11e by the bolts 11f and the nut 11g screwed on the bolts 11f. As shown in FIG. 4, a mesh size M of the superposed screen plates 11a is adjustable by sliding the screen plates 11a in the direction of elongated through holes 11c before fasten the nuts 11g on the bolt 11f to fix the screen plates 11a. The other pairs of screen plates 11a are mounted on the brackets 11e in the same manner to form the eight screen faces of the polygonal screen unit 11. It is preferable to set the shortest distance between the vanes 8 and the screen plate 11a to approximately 2 mm.

The round screen unit 12 has a plurality of segmented screen faces in the circumferential direction thereof. Each of the segmented screen faces is constituted by superposing a pair of curved screen plates 12a. Each screen plate 12a has a plurality of longitudinal through holes (slits) 12b extending in the vertical direction and an oval through hole 12c elongated in the circumferential direction at both side ends thereof. The pair of screen plates 12a are superposed each other and attached to brackets 12e which are fixed to upper and lower ring plates 12d by welding, etc. Bolts 12f are provided at attachment faces of the brackets 12e for insertion into the oval through holes 12c of the screen plates 12a, and each pair of the two screen plates 12a are detachably mounted on the attachment faces of the adjacent brackets 12e by the bolts 12f and the nut 12g screwed on the bolts 12f. As shown in FIG. 5, a mesh size N of the superposed screen plates 12a is adjustable by sliding the screen plates 12a in the direction of elongated through holes 12c before fasten the nuts 12g on the bolt 12f to fix the screen plates 12a. The other pairs of screen plates 12a are mounted on the brackets 12e in the same manner to form the segmented eight screen faces of the round screen unit 12. It is preferable to set the shortest distance between the vanes 8 and the screen plate 12a to approximately 2 mm.

A ground product discharging path 13 for discharging the ground product passed through the mesh M of the polygonal screen unit 11 and the mesh N of the round screen unit 12 is formed annularly outside the screen cylinder 10. The ground product discharging path 13 is formed by a peripheral portion 6b of the rotary base 6, an upright wall 14 arranged at the periphery of the rotary base 6, a top plate 15 covering an upper opening of the apparatus, and the screen cylinder 10. An outlet 14a is formed on the upright wall 14 to which one end of a ground product conducting tube 16 is connected for conducting the ground product from the ground product discharging path 13. The other end of the ground material conducting pipe 16 is connected with a suction fan (not shown). The upright wall 14 is divided into two parts which are connected together by bolts/nuts 14b to be detachable from the apparatus. An upper end of the upright wall 14 is attached to the top plate 15 by bolts 14c and an lower end of the upright wall 14 is attached to the peripheral portion 6b of the rotary base 6 by bolts 14d to be detachable therefrom.

The polygonal screen unit 11 is placed on the ring plate 12d of the round screen unit 12 and fixed to the top plate 15. Bolts 15a are inserted into the through hole formed on the top plate 15 and rotated to engage with the threaded holes 15a formed on the ring plate 11d at positions corresponding to the through holes on the top plate 15, so that the polygonal screen unit 11 is fixed to the top plate 15. The round screen unit 12 is fixed to the round base 6 by bolts 6a inserted into the through holes formed on the round base 6 and rotated to engage with the threaded holes 18 formed on the lower ring plate 12d at corresponding position to the through holes.

An inlet 15b for introducing the material such as grains is formed at a center of the top plate 15 and a material supply pipe 19 for supplying the material is connected to the inlet 15b and fixed by bolts/nuts. An air supply pipe 20 for supplying air into the supply pipe 19 is connected to the supply pipe 19 in the vicinity of the inlet 15b.

Operation of the impact grinding apparatus 1 will be described. The spindle 4 is rotated by a rotating force transmitted from the driving motor to rotate the rotary disk 7. It is preferable to set a rotational speed of the rotary disk 7 to approximate 3000 rpm. The vanes 8 on the rotary disk 7 move inside the inner circumference of the screen cylinder 10 at high speed. After starting an operation of the suction fan, the material to be ground and the air are supplied into the impact grinding apparatus 1 from the inlet 15b through the material supply pipe 19 and the air supply pipe 20, respectively. The material supplied from the inlet 15b drops on the rotary disk 7 and is forced to leap in the radial direction by the centrifugal force produced by the rotation of the rotary disk 7 and the air suction of the suction fan to pass through the gaps of the vanes as being thrust thereby, and impacts against the polygonal screen unit 11 and the round screen unit 12 randomly.

The material impacted on the polygonal screen unit 11 is ground, and the material not ground is thrust by the vanes 8 to be impacted against the polygonal screen unit 11 repeatedly. The ground material having particle diameters smaller than the mesh M of the polygonal screen unit 11 passes through the mesh M and discharged through the ground product discharging path 13 and the ground product conveying pipe 16. The material which does not pass through the mesh M of the polygonal screen unit 11 and remains in the first grinding chamber F1 drops into the second grinding chamber F2 and is ground in the second chamber F2. Since the first grinding chamber F1 is formed between the vanes 8 and the polygonal screen unit 11, the supplied material is fed to corner portions K to increase capability of processing amount of material, as shown in FIG. 4.

The material impacted on the round screen unit 12 is ground, and the material not ground is thrust by the vanes 8 to be impacted against the round screen unit 12 repeatedly. The ground material having particle diameters smaller than the mesh N of the round screen unit 12 passes through the mesh N and discharged through the ground product discharging path 13 and the ground product conveying pipe 16. The material which has not ground in the first grinding chamber F1 is completely ground in the second chamber F2 by the repeated impact against the round screen unit 12 as being thrust by the vanes 8.

Since each of the screen faces of the polygonal screen unit 11 and the round screen unit 12 is formed by superposing two screen plates, strength and durability of the screen faces are enhanced. Further, in a state of one of the upright walls 14 removed, the mesh sizes can be adjusted easily by displacing the screen plates relative to each other after loosening the nuts 11g or the nuts 12g and thus it is not necessary to replace the screen cylinder for changing the mesh size. Further, since the screen cylinder 10 comprises two units of the polygonal screen unit 11 and the round screen unit 12, different mesh sizes may be set to the polygonal screen unit 11 and the round screen unit 12. Furthermore, since each of the screen faces of the polygonal screen unit 11 and the round screen unit 12 is constituted by the plurality of divided screen plates, it is possible to set different mesh sizes to the respective screen plates. By setting the different mesh sizes, ground product having different particle diameters can be obtained. Thus, it is not necessary to process the material by a plurality of grinding apparatuses having different mesh sizes.

Various modifications of the impact grinding apparatus will be described. In the foregoing embodiment, the screen cylinder 10 is constituted by two units of the upper screen unit and the lower screen unit. The screen cylinder 10 may be constituted by more than two screen units to increase amount of material to be processed. In this case, various combinations may be adopted in selecting shapes of the respective screen units, e.g. a combination of the polygonal screen units and the round screen units alternately arranged or a combination of the round screen unit as the lowermost one and the polygonal screen units as the rest, and further, the polygonal screen units only or the round screen units only. Further, the screen cylinder 10 may be constituted by a single polygonal screen unit or round screen unit which has different mesh sizes in the divided screen faces.

In the case where height of the screen cylinder 10 is considerably large, it is preferable to provide distribution paths under the inlet 15b so that the supplied material is guided to the grinding chambers uniformly. The height of the vanes 8 is set to corresponding to the height of the screen cylinder 10. The screen plate may be embossed such that the material is impacted on bosses to enhance the efficiency of grinding. The longitudinal through holes (slits) of the screen plate extend in the vertical direction in the foregoing embodiment. However, the longitudinal through holes may be inclined from the vertical direction in view of the processing efficiency and granularity of product.

What is claimed is:

1. An impact grinding apparatus for grinding grains, comprising:
an inlet for introducing material to be ground;
a rotary disk arranged rotatably under said inlet, and having a plurality of vanes arranged at a periphery thereof and directed in an approximately radial direction;
a screen cylinder stationarily arranged outside the plurality of vanes of said rotary disk and having screen faces constituted by a plurality of screen plates detachably mounted thereon; and
an annular path arranged outside said screen cylinder for discharging ground product passed through said screen cylinder.

2. An impact grinding apparatus according to claim 1, wherein each of the screen faces of said screen cylinder comprises a plurality of superposed screen plates arranged slidable relative to each other.

3. An impact grinding apparatus according to claim 1, wherein said screen cylinder is constituted by a plurality of screen units stacked in the vertical direction.

4. An impact grinding apparatus according to claim 1, wherein said screen units include a round screen unit and a polygonal screen unit.

5. An impact grinding apparatus according to claim 1, wherein each of said screen plates has a plurality of slits extending in the vertical direction.

6. An impact grinding apparatus according to claim 1, wherein at least one of said screen plates is embossed on a side facing said rotary disk.
